(19) United States
(12) Patent Application Publication
(10) Pub. No.: US 2014/0362518 A1
(43) Pub. Date: Dec. 11, 2014

(54) THERMAL MANAGEMENT OF A PORTABLE COMPUTING DEVICE

(71) Applicants: Wei Huang, Austin, TX (US); William L. Bircher, Austin, TX (US)

(72) Inventors: Wei Huang, Austin, TX (US); William L. Bircher, Austin, TX (US)

(21) Appl. No.: 13/913,692

(22) Filed: Jun. 10, 2013

(51) Int. Cl. G06F 1/20

(52) U.S. Cl. CPC G06F 1/206
USPC 361/679.46; 29/592.1

(57) ABSTRACT

Various computing devices and methods of thermally managing the same are disclosed. In one aspect, an apparatus is provided that includes a case and a first sensor in the case. a case and a first sensor in the case. The first sensor is operable to generate an output in response to sensing contact with a body part of a user. The computing device manages thermal behavior of the computing device responsive to the output.

### BACKGROUND OF THE INVENTION

1. Field of the Invention

This invention relates generally to computing devices and software, and more particularly to thermal management of portable computing devices.

2. Description of the Related Art

Handheld computing devices, such as smart phones, tablet computers and e-book readers, present significant thermal management challenges. There is ongoing user demand for devices that are not only smaller form factor for greater portability but also powerful enough to handle video and other computing intensive tasks. The provision for significant computing power in a relatively small form device often translates into the need for significant thermal management of the heat dissipating devices.

One common solution used to transfer heat from a processor in a small form device includes the use of a heat spreader that is in thermal contact with the processor. The heat spreader is in turn, in thermal contact with a heat exchanger via a heat pipe or other structure. The heat exchanger often includes an air mover such as a fan. One example of such a conventional device is the model LE1700 manufactured by Motion Computing, Inc. The LE1700 includes a very thin fan connected thermally to a heat spreader mounted to the microprocessor and by way of a heat pipe. The fan vents air to the external ambient by way of a small vent. An Acer model Iconia is another conventional example.

Even with the conventional thermal management system just described in place, hot spots on the surface of the computing device that contact the user can arise due to direct conductive thermal pathways between heat dissipating components inside the device and the exterior wall of the device housing. Not only does a typical handheld microprocessor dissipate heat, but other components as well, such as hard drives, power supply units, batteries and others. Indeed, the problem of heat dissipation is often exacerbated during times when the computing device is connected to an external AC power source to recharge the battery.

For many conventional thermal management schemes for portable computing devices, the control target is silicon junction temperature. In most cases, this involves sensing junction temperature of the main processor of the computing device, although chips might serve this purpose. Unfortunately, the silicon junction temperature sensor may not correlate with the temperature of the device's exterior or those portions in skin contact. This may produce a less than optimal user experience. In addition, the thermal management is not localized.

The present invention is directed to overcoming or reducing the effects of one or more of the foregoing disadvantages.

### SUMMARY OF EMBODIMENTS OF THE INVENTION

In accordance with one aspect of an embodiment of the present invention, an apparatus is provided that includes a case and a first sensor in the case. The first sensor is operable to generate an output in response to sensing contact with a body part of a user. The computing device manages thermal behavior of the computing device responsive to the output.

In accordance with another aspect of an embodiment of the present invention, a computing device is provided that includes a handheld case and a first sensor in the handheld case. The first sensor is operable to generate an output in response to sensing contact with a body part of a user. An integrated circuit is connected to the first sensor and programmed to manage thermal behavior of the computing device in response to the output of the first sensor.

In accordance with another aspect of an embodiment of the present invention, a method of thermally managing a computing device that includes a case, a first sensor in the case and an integrated circuit connected to the first sensor is provided. The method includes using the first sensor to sense contact by a body part of a user and generate an output indicating the contact. Thermal behavior of the computing device is managed in response to the output of the first sensor.

In accordance with another aspect of an embodiment of the present invention, a method of manufacturing includes providing a case of a computing device. The case is adapted to contact a body part of a user. A first sensor is placed in the case. The first sensor is operable to generate an output in response to sensing contact with a body part of a user and to transmit the output to a computing device. The computing device manages thermal behavior of the computing device responsive to the output.

In accordance with another aspect of an embodiment of the present invention, a method of thermally managing a computing device that includes a case, a first sensor in the case and an integrated circuit connected to the first sensor. The method includes using the first sensor to sense a spatial orientation of the computing device and generate an output indicating the spatial orientation. The thermal behavior of the computing device is manages in response to the output of the first sensor.

In accordance with another aspect of an embodiment of the present invention, an apparatus is provided that includes a computing device operable to receive an output of a first sensor positioned in a case. The output is generated in response to sensing contact with a body part of a user. The computing device manages thermal behavior of the computing device responsive to the output.

### BRIEF DESCRIPTION OF THE DRAWINGS

The foregoing and other advantages of the invention will become apparent upon reading the following detailed description and upon reference to the drawings in which:

FIG. 1 is a pictorial view of an exemplary embodiment of a computing device seated on a supporting surface;

FIG. 2 is a pictorial view of an exemplary embodiment of a computing device held in a position by a user;

FIG. 3 is a sectional view of FIG. 2 taken at section 3-3;

FIG. 4 is a pictorial view of an exemplary embodiment of a computing device held in another position by a user;

FIG. 5 is a plan view of a backside of an alternate exemplary embodiment of a computing device;

FIG. 6 is a plan view of a backside of another alternate exemplary embodiment of a computing device;

FIG. 7 is a system block diagram of an exemplary embodiment of a computing device;

FIG. 8 is a flow chart depicting exemplary process steps in an exemplary computing device control loop;

FIG. 9 is a flow chart depicting additional exemplary process steps in an exemplary computing device control loop;

FIG. 10 is a flow chart depicting additional exemplary process steps in an exemplary computing device control loop;

FIG. 11 is a flow chart depicting additional exemplary process steps in an exemplary computing device control loop;

FIG. 12 is a flow chart depicting additional exemplary process steps in an exemplary computing device control loop; and

FIG. 13 is a flow chart like FIG. 12, but depicting additional exemplary process steps in an exemplary computing device control loop.

### DETAILED DESCRIPTION OF SPECIFIC EMBODIMENTS

Various embodiments of a computing device are disclosed. In one arrangement, a computing device, such as a tablet computer, includes a case with one or more case-mounted sensors to sense temperature and/or pressure. The sensors are used to sense contact with a body part of a user. The computing device may manage its thermal behavior using the outputs of the sensor(s). Highly localized thermal management, even localized to the point of skin contact, may be achieved. Additional details will now be described.

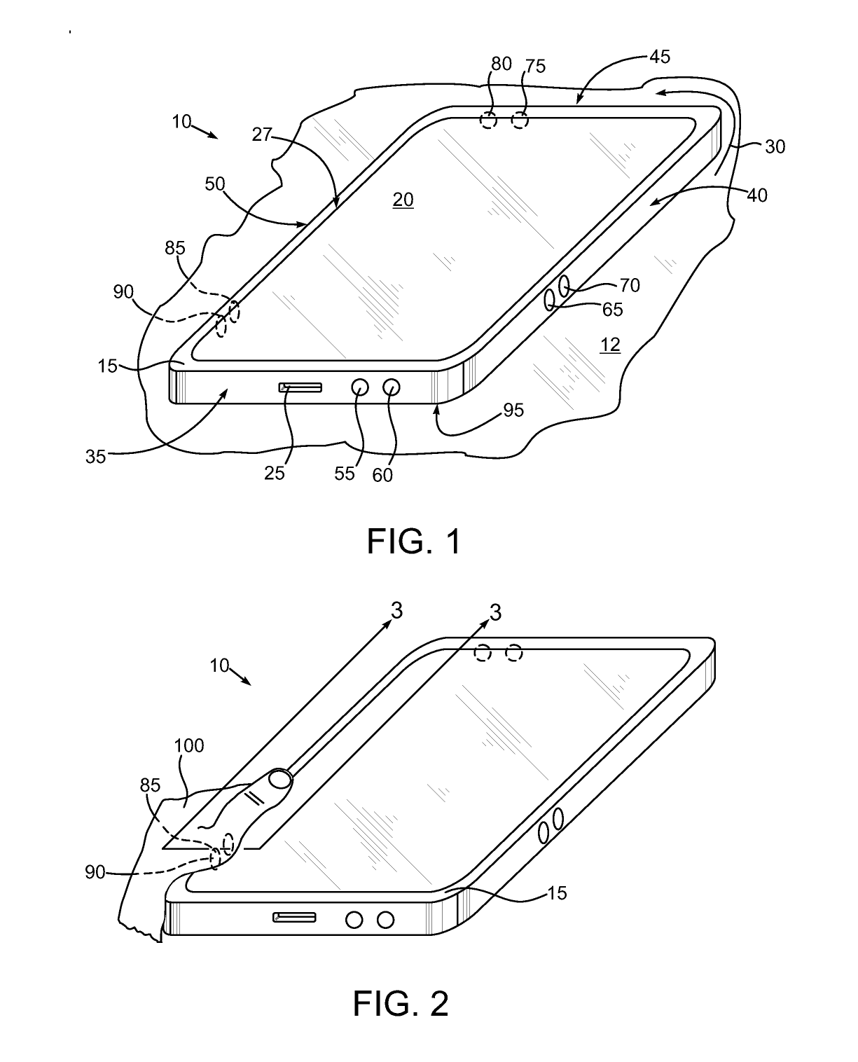

In the drawings described below, reference numerals are generally repeated where identical elements appear in more than one figure. Turning now to the drawings, and in particular to FIG. 1, therein is shown a pictorial view of a computing device 10 seated, at least in this figure, on a supporting surface 12, such as a desk or table. The computing device 10 may take on a virtually limitless number of form factors. Examples include tablet computers, smart phones, hand held computers, remote controls or others. In this exemplary embodiment, the computing device 10 may be a tablet computer that includes a case 15 and a screen 20. The screen 20 may be touch enabled or not as desired. The computing device 10, as a tablet computer, may include multiple ports, one of which is visible and labeled 25. Other ports will be visible in subsequent figures. Again it should be understood that FIG. 1 simply illustrates one of the many possibilities of a physical implementation of the computing device 10.

The case 15 includes a sidewall 27 with an outer perimeter 30 that may take on a variety of geometric shapes. For example, in this illustrative embodiment, the case 15 and thus the perimeter 30 is rectangular and the sidewall 27 is made up of adjoining edges 35, 40, 45 and 50. The edges 35, 40, 45 and 50 may be populated with plural sensors. In this regard, the edge 35 may include sensors 55 and 60, the edge 40 may include sensors 65 and 70, the edge 45 may include sensors 75 and 80 and the edge 50 may include sensors 85 and 90. It should be understood, and as will be described in more detail below, that the number, type and positioning of the sensors 55, 60, 65, 70, 75, 80, 85 and 90 may be other than what is shown in FIG. 1 and subject to great variation. As described further below, the backside 95 of the case 15 may also include sensors that are not visible in FIG. 1. The sensors 55, 60, 65, 70, 75, 80, 85 and 90 are designed to sense temperature and/or pressure, such as the ambient temperature as well as temperature associated with the skin temperature of a user grasping the computing device 10. Thus, for example, any of the sensors 55, 60, 65, 70, 75, 80, 85 and 90 can be a temperature sensor or a pressure sensor. In this way, one or more of the sensors 55, 60, 65, 70, 75, 80, 85 and 90 can pick up indications of increased temperature or touch by a user and those readings can be used to modify the thermal behavior of the computing device 10 as described in more detail below. For example, and as shown in FIG. 2, if a user's body part, such as a hand 100, grasps the computing device 10 and holds it in portrait mode as depicted in FIG. 2, the sensors 85 and 90 in the case 15 may sense the temperature of, as well as the pressure applied by, the hand 100 and the computing device 10 may modify the thermal control of the computing device 10 based on those readings to provide a better user experience while holding the computing device 10. Examples of temperature sensors include thermocouples, thermoelectric devices or others. Examples of pressure sensors include transducers, image sensors, piezoelectric devices, ordinary strain gauges or others.

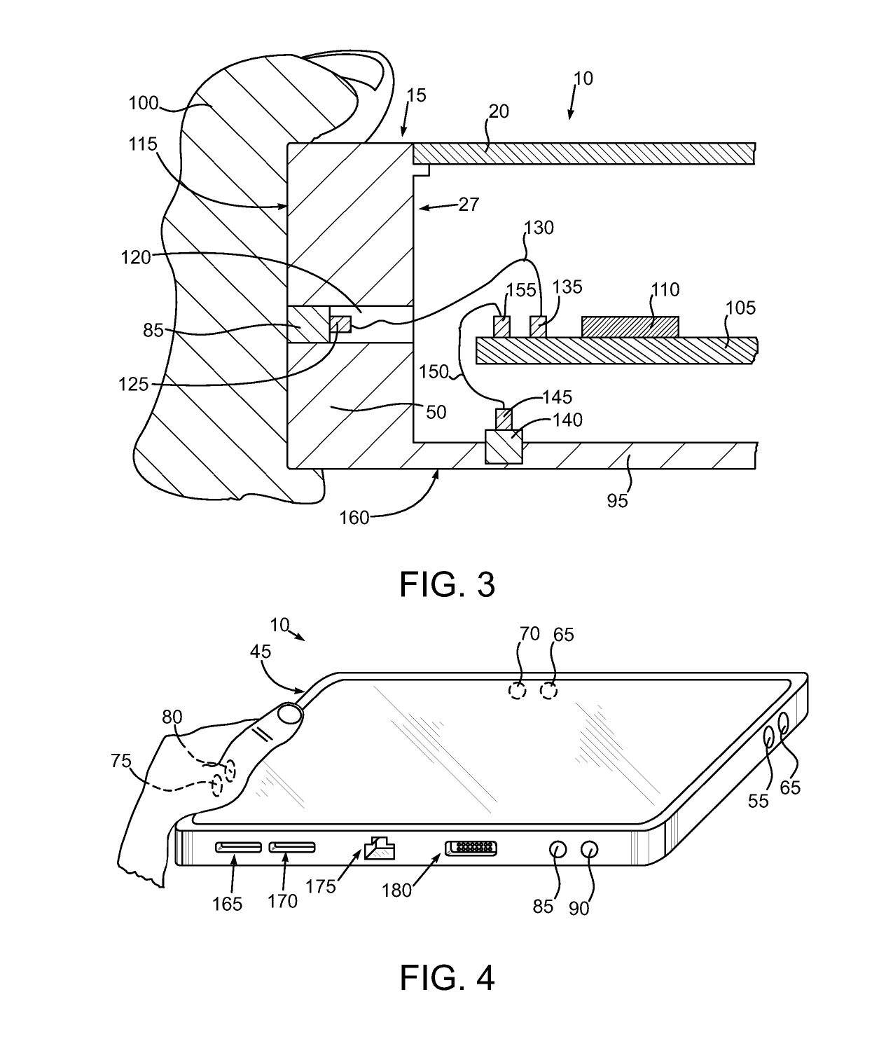

Additional details of the computing device 10 may be understood by referring now to FIG. 3, which is a sectional view of FIG. 2 taken at section 3-3. Note that section 3-3 passes through a portion of the user's hand 199 as well as the edge 50 of the sidewall 27 of the case 15. Note also that because of the location of section 3-3, a small portion of the display 20 and the back side 95 of the case 15 are visible. In addition, a small portion of a system board 105 for the computing device 10 is shown and may include one or more components, one of which is labeled 110. The component 110 may be an integrated circuit, such as a processor, or any other type of integrated circuit. The sensor 85 at the edge 50 is shown in section and may be flush with the outer surface 115 of the edge 50 as shown or recessed as desired. Here, the sensor 85 may be positioned in a bore or other opening 120 in the edge 50 and be connected to the system board 105 by way of a connector 125, a wire or cable 130 and a corresponding connector 135 on the system board 105. The connectors 125 and 135 may be pins, solder, plugs or virtually any type of electrical connection. In addition, one or more sensors, one of which is visible and labeled 140, may be mounted in the backside 95 of the case 15. The sensor 140 may be a temperature or pressure sensor as described above, and connected to the system board 105 by way of a connector 145, a cable or wire 150 and a corresponding connector 155 on the system board 125. The connectors 125, 135, 145 and 155 may be pins, solder, plugs or virtually any type of electrical connection. Here, the sensor 140 is depicted as being slightly recessed from the outer surface 160 of the backside. Thus, any of the sensors 85, 140, etc. disclosed herein may be flush or recessed. Indeed, any of the sensors 85, 140, etc. disclosed herein may be positioned in the case, where “in” as used herein includes flush, recess or other positioning.

As noted above, FIG. 2 depicts the computing device 10 in portrait position relative to the user's hand 100, such that the edge 50 is engaged. Of course, if the user's hand 100 grasps any of the other edges 35, 40 or 45 then the sensors 55 and 60 or 65 and 70 or 75 and 80 would detect the presence of the user's hand 100 and thermal control adjustments may be made accordingly. In this regard, attention is now turned to FIG. 4, which is a pictorial view of the computing device 10 grasped by the user's hand 100, but in this case with the computing device 10 rotated into landscape position such that the user's hand 100 is grasping the edge 45 instead of the edge 50 as shown in FIG. 2. In this orientation, the presence of the user's hand 100 will be detected by the sensors 75 and 80. In this landscape orientation, the formerly visible sensors 65 and 70 are now obscured and thus shown in phantom and the formerly phantom-depicted sensors 85 and 90 are now visible while the sensors 55 and 60 remain visible as well. A few additional exemplary ports are visible such as USB 3.0 ports 105 and 110, a wired ethernet port 115 and a video port 120. Again, the skilled artisan will appreciate that the existence, number and types of ports is subject to great variety.

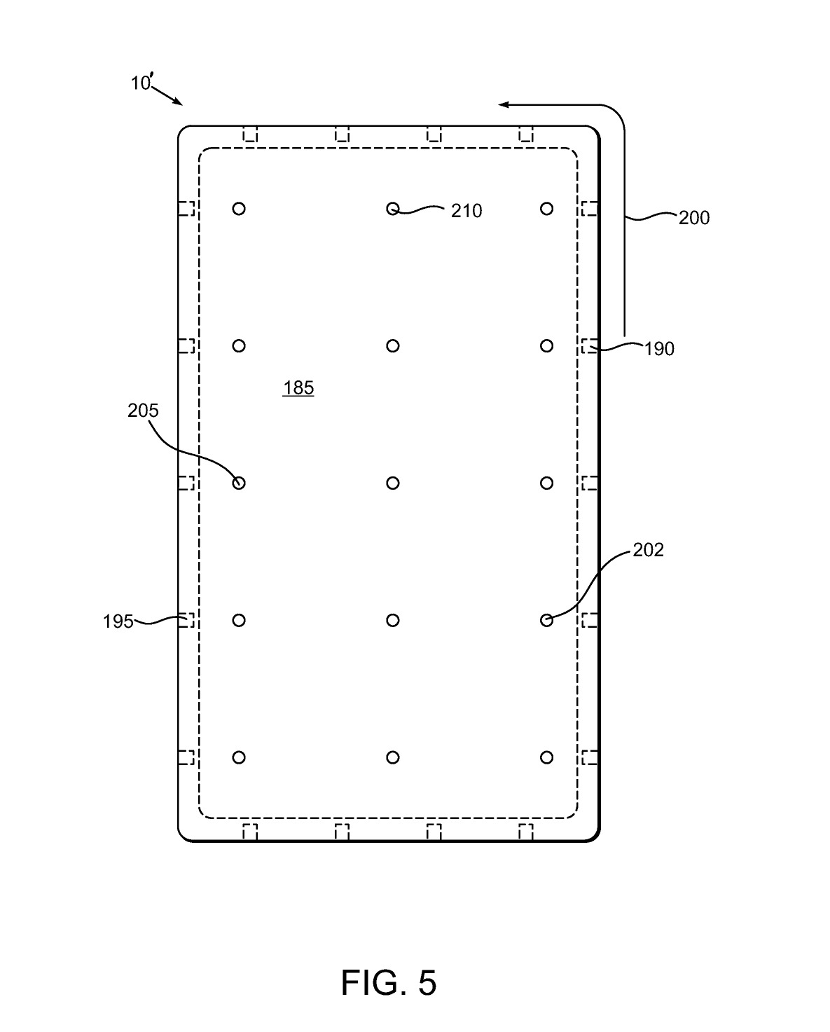

As noted briefly above, the various environmental sensors, such as the temperature and pressure sensors, may be positioned at various positions around the perimeter and otherwise of a computing device. FIG. 5 depicts an exemplary embodiment of a computing device 10′, which is shown flipped over so that a backside 185 thereof is visible. Here again, multiple sensors, two of which are labeled 190 and 195, may be positioned at various locations around a perimeter 200 of the computing device 10′ and other sensors 202, 205 and 210 may be positioned at various locations on the backside 185. The various sensors 190, 195, 202, 205 and 210 may be configured and function like the sensors 55, 60, 65, 70, 75, 80, 85 and 90 described elsewhere herein.

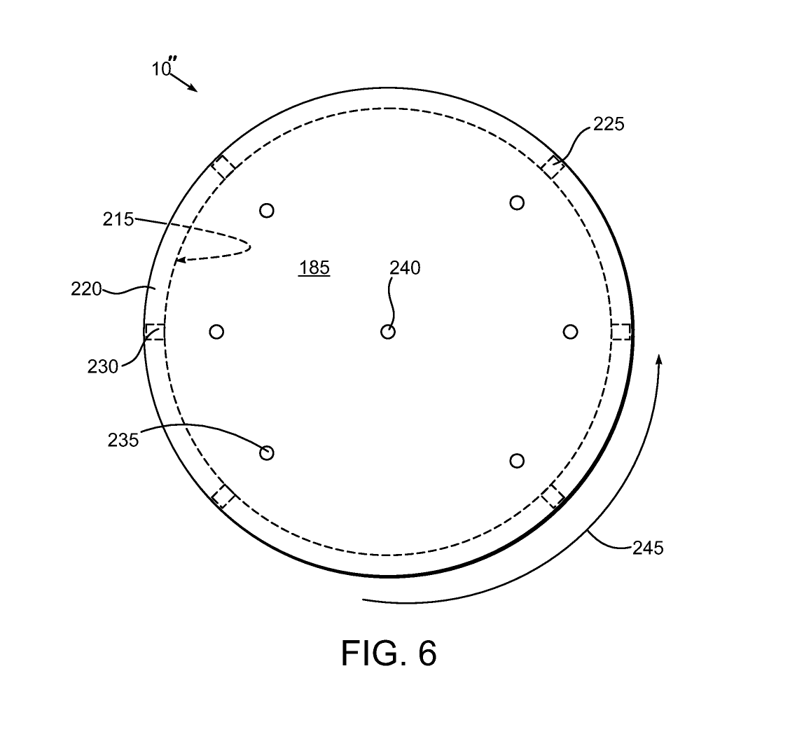

As noted briefly above, the computing device may take on a variety of form factors. FIG. 6 depicts a plan view of a backside 185 of a computing device 10″ that has a generally circular form factor. Here, an interior wall 215 of a case 220 is shown in dashed. Various temperature and pressure sensors, of the type described elsewhere herein, may be fitted to the computing device 10″. A few of these sensors are labeled 225, 230, 235 and 240. Some of the sensors 225 and 230 may be positioned around a perimeter 245 and others in the backside 185 of the computing device 10″ as shown. The skilled artisan will appreciate that other form factors may be used.

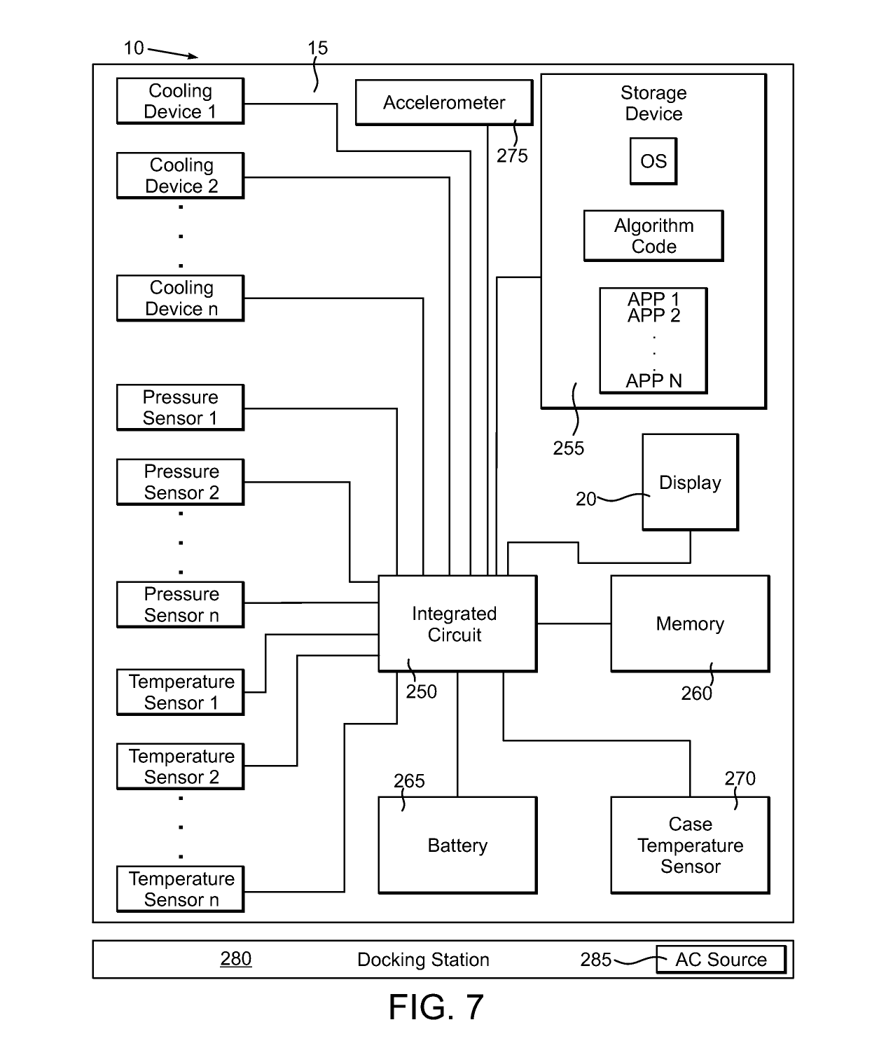

Additional details of an embodiment of the cooling device 10 may be understood by referring now to FIG. 7, which is a system block diagram. In this illustrative embodiment, the case 15 may house a variety of components, which may be electric devices and/or electronic devices. For example, the case 15 may house an integrated circuit 250, a storage device 255, memory 260, a battery 265, the aforementioned display 20, a case temperature sensor 270, and an accelerometer 275 that is operable to sense movements of the computing device 10. The integrated circuit 250 may be a microprocessor, a graphics processor, a combined microprocessor/graphics processor, an application specification integrated circuit or other type of integrated circuit. The storage device 20 is a computer readable medium and may be any kind of hard disk, optical storage disk, solid state storage device, ROM, RAM or virtually any other system for storing computer readable media. The storage device 20 may be populated with plural applications, which are abbreviated APP1, APP2 . . . APPn, as well as an operating system OS and ALGORITHM CODE, which may be designed to implement control of the electrical behavior of various components of the computing device 10 to thereby control the surface temperature of the case 15. The various pieces of code may be loaded into the memory 260 as needed. Windows®, Linux, or more application specific types of operating system software may be used or the like.

The case 15 may also house one or more optional Cooling Devices 1, 2 . . . n, one or more Pressure Sensors 1, 2 . . . n and one or more Temperature Sensors 1, 2 . . . n. The Cooling Devices 1, 2 . . . n may be ventilation fans or other type of heat exchange devices. The Pressure Sensors 1, 2 . . . n and the Temperature Sensors 1, 2 . . . n may correspond to any of the sensors 55, 60, 65, 70, 75, 80, 85, 90 or others disclosed herein. The computing device 10 may be operable to dock with a docking station 280, which may include an AC source 285 to supply power to the computing device 10 and to recharge the battery 265 as necessary. The computing device 10 may be operable to sense positioning in and removal from the docking station 280 either by way of a specific electronic signal or by a reading from the accelerometer 275 or both.

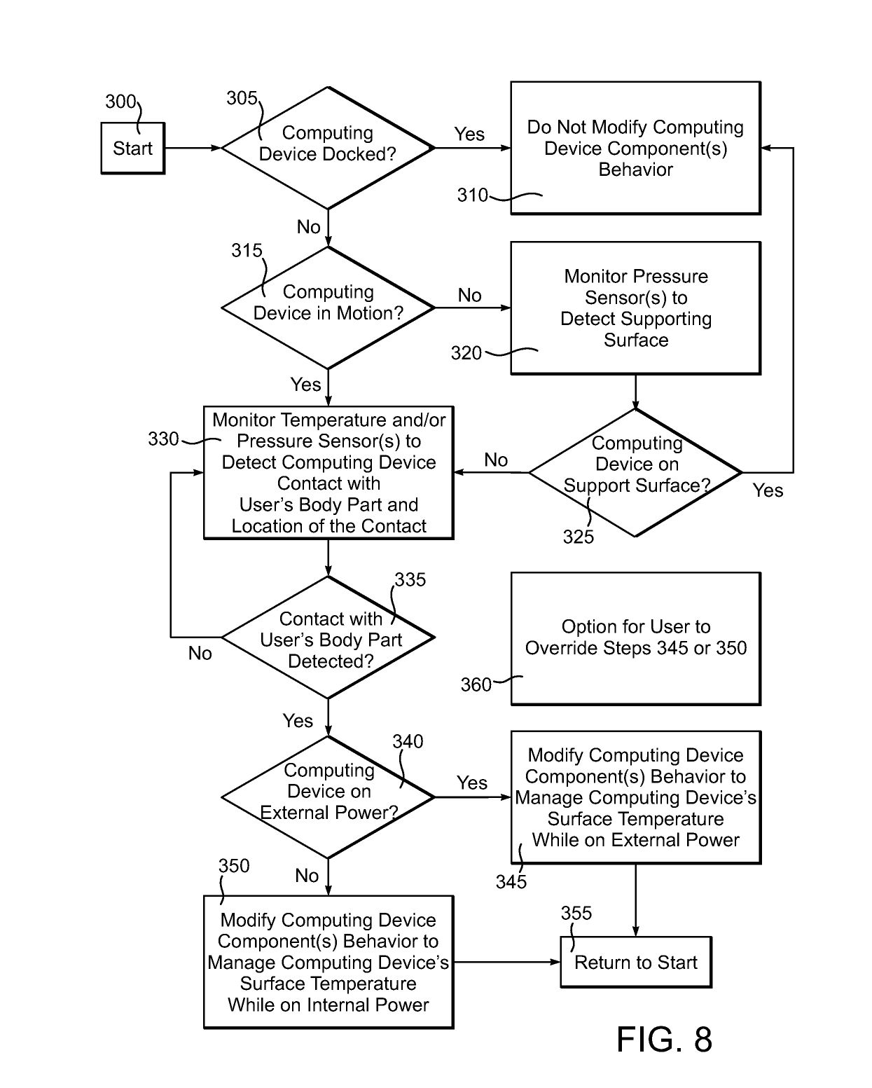

The collection of data from a peripherally or otherwise-based temperature and/or pressure sensors may be used in a variety of ways to control the thermal characteristics of the computing device 10. Attention is now turned to FIG. 7, and to FIG. 8, which is a schematic of an exemplary control loop that may be used with the computing device 10 (or any disclosed alternatives). Following a start step 300 of the loop in FIG. 8, a determination is made at step 305 as to whether or not the computing device 10 is docked to some form of docking station, such as the station 280. This step is optional in the event that the computing device 10 is incapable of docking with a docking station. If the device 10 is determined to be docked at step 310, then it is not necessary to modify any of the components behavior since the device will typically not be in contact with the user's skin at that point. If, however, at step 310 it is determined that the device 10 is not docked then a determination is made at step 315 as to whether or not the device 10 is in motion. If the device 10 is in motion, then there is a high probability that the device 10 is about to come in contact with the user's skin and thus the monitoring of temperature sensors should commence accordingly. However, if the device 10 is not detected to be in motion then at step 320 the computing device 10 will monitor pressure sensors such as those sensors located on the backside of the device depicted in FIG. 5, to detect the presence of a supporting surface. The objective is for the computing device 10 to look at pressure sensor reading and determine if the device is sitting on a table or other supporting surface. If the device is determined at step 325 to be on a supporting surface then return is made to step 310 since there is no reason to modify the behavior of the device components due to the likelihood that the device 10 is not in contact with the user's skin and thus will not require thermal behavior modification. If on the other hand at step 325, if it is determined that the computing device 10 is not on a supporting device, then the algorithm code will proceed to step 330. The code will also proceed to step 330 at the conditional 315 where it is determined whether or not the device 10 is in motion. At step 330, the device 10 will monitor the Pressure Sensors 1, 2 . . . n and the Temperature Sensors 1, 2 . . . n to detect device contact with a user's body part and the location of the contact. If it is determined at step 335 that there is no contact with the user's body part then the algorithm code will loop back to step 330 and continue monitoring the Pressure Sensors 1, 2 . . . n and the Temperature Sensors 1, 2 . . . n for device contact with the user's body part. If, however, at step 335 contact with the user's body part, the device 10 decides at step 340 if it is on external power. It may or may not be desirable to modify the behavior of the components of the device 10 depending upon whether or not the device is on external power since often the device will incur a greater heat load while on external power due to battery charging or the very influx of current into the device from an external power source. Therefore, if it is determined at step 340 that the device 10 is on external power then at step 345, the behavior of device components may be modified to manage the device's surface temperature while on external power. The types of behavior modification for device components will be described in further detail below. Conversely, if at step 340 it is determined that the device 10 is not on external power then at step 350, the behavior of the device components may be modified to manage the device's surface temperature while on internal power. Again this device behavior modification may take into account the fact that the device 10 operating on internal power will typically not have the increased heat load associated with connection to external power. Finally, the loop is completed at step 355 and a return to start is commenced. This control loop may be run continuously while the computing device 10 is turned on. An option for the user to override the modification steps of steps 345 or 350 may be incorporated into the control loop as step 360.

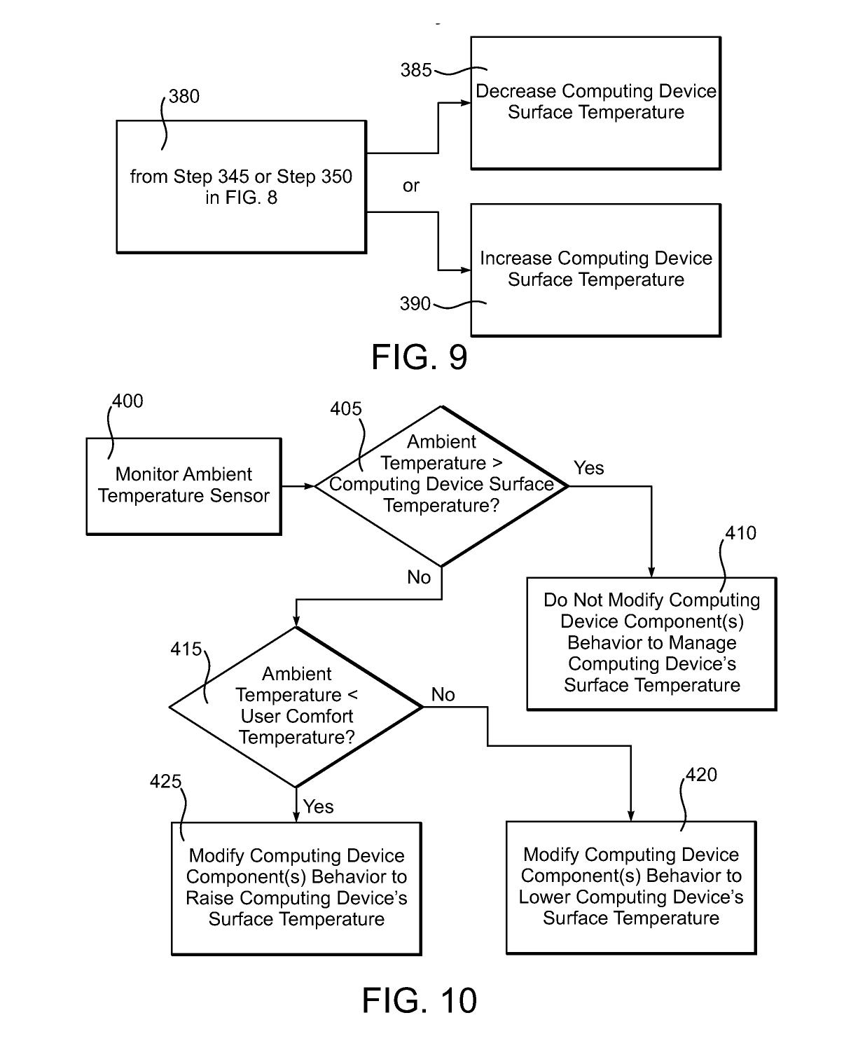

Some additional control methodology that may be incorporated into the basic control loop depicted in FIG. 8 may be understood by referring now to FIG. 9. Step 380 picks up at the execution of steps 345 or 350 in FIG. 8. Here, it should be understood that the modification of the behavior of device components to manage the device's surface temperature may be performed to either, at step 385, decrease the surface temperature of the device 10 or, at step 390, increase the surface temperature of the device 10. Decreasing the surface temperature at step 385 may be appropriate in circumstances where the device surface temperature is determined to exceed, for example, normal human body temperature by some preselected amount and vice versa at step 390 where the surface temperature of the device is lower than some preselected temperature that is below normal human body temperature.

Some modifications to the basic control loop depicted in FIG. 8 may be understood by referring now to FIGS. 7-8 and to FIG. 10, which is a flow chart depicting some additional steps. Here, the initial step at 400 is the monitoring of an ambient temperature sensor. This step may be performed just after step 330 in FIG. 8 for example. The purpose of monitoring ambient temperature sensor step 400 is to enable the device 10 to modify or not the behavior of device components based on the ambient temperature that the device is experiencing. For example, if the device 10 is being used outdoors in a high temperature environment, it may not make any sense to modify the electrical behavior of the device components if the device 10 itself is operating at a surface temperature that is below the ambient temperature. Conversely, if the device 10 is located in the ambient temperature that is dramatically lower than the device surface temperature, such as in a cold environment, it may be desirable to modify the behavior of device components in order to raise the heat load of the device 10 and thus make the device 10 more comfortable for the user to carry or to hold in the cold. As noted briefly above in conjunction with FIG. 7, the ambient temperature sensor may be any of the Temperature Sensors 1, 2 . . . n that is dedicated to measuring ambient temperature. Once the ambient temperature is being monitored, then at step 365, it is determined whether the ambient temperature is greater than the device surface temperature. Here, the ambient temperature as determined in step 360 will be measured or be compared to the device surface temperature as read in step 330 in FIG. 8 and then a comparison is made. Then at step 370, it may be decided to not modify the behavior of the device components to manage the device's surface temperature. Conversely, if at step 365 it is determined that the ambient temperature does not exceed the device surface temperature then at step 375 the behavior of the device components may be modified to manage the device's surface temperature. In this regard, and assuming that the ambient temperature is less than the device surface temperature, it may make sense at step 375 to take steps to lower the device surface temperature to increase the comfort level of the user.

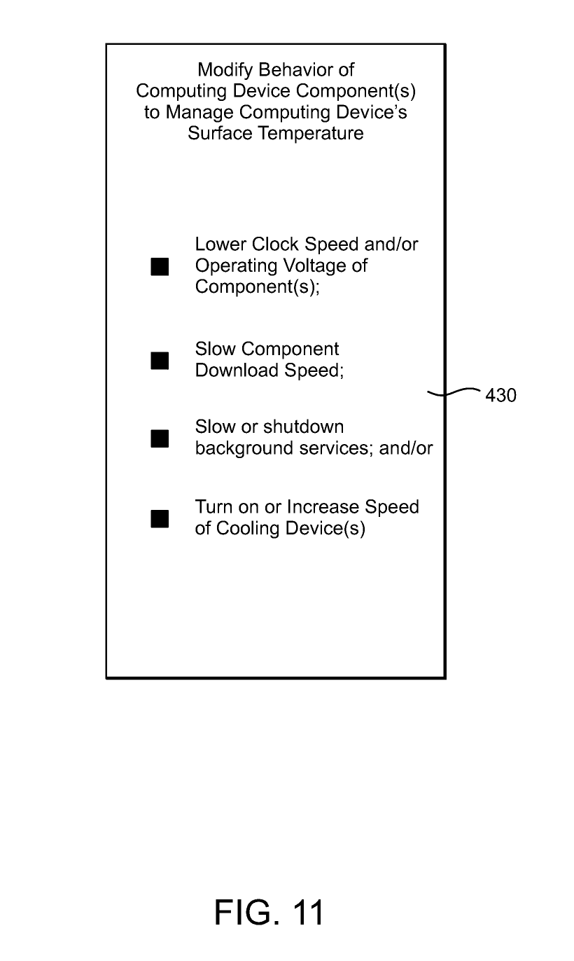

Some additional details of steps 345 and/or 350 depicted in FIG. 8 may be understood by referring now to FIG. 11, which is an added portion of the flow chart of FIG. 8. In this illustrative embodiment, the step 430 of modifying the behavior of device components to manage the device's surface temperature may come in a variety of forms. These forms may be used individually or in concert. For example, in order to modify the behavior of the device components to manage the device's surface temperature, the clock speed and/or operating voltage of the components may be lowered, or a component download speed for an ethernet connection and ethernet chip combination may be slowed or otherwise throttled in order to reduce the heat load associated with the download operation. Similarly, background services may be slowed or shut down and finally the cooling devices may be turned on or increased in operating speed. The examples of the types of background services that may be slowed or shut down are legion and includes such things as various other applications that are running such as anti-virus, email push, browsers or any of the other variety of types of applications that may be running. The types of cooling devices that may be turned on or increased in speed are things such as cooling fans or the like. With regard to lowering clock speed and/or operating voltage of components, it should be understood that for multi-core devices the clocking and voltage may be modified on a per core basis as desired.

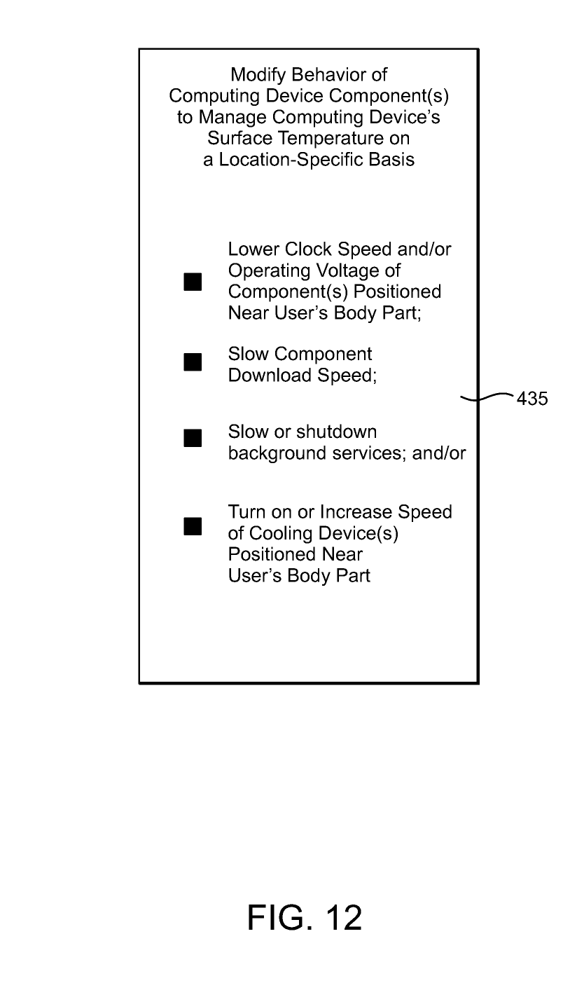

It should be understood that step 430 in FIG. 11 depicts a generally global behavior modification of components within a given device 10. However, and as depicted in FIG. 12, the skilled artisan will appreciate that the modification of device component behavior may be performed on a location-specific basis based on the detection of user skin contact at a particular location on the device 10. As noted above, the Pressure Sensors 1, 2 . . . n and/or the Temperature Sensors 1, 2 . . . n are operable to pinpoint the location of user skin contact with the device 10. Thus, as shown in block 435, which is an alternate embodiment of the block 430 depicted in FIG. 11, a variety of different types of device component behavior modification steps will be performed on a localized basis such as lowering clock speed and/or voltage of components positioned near the user's body part, again the slowing of a component download speed, the slowing or shutting down of background surfaces and/or the turning on or increase in speed of cooling devices positioned near a user's body part. Thus, it may be possible to modify the clock speed and operating voltage of those components that are nearest to the user's body part in contact with the device 10 and the same is true for modifying the operating characteristics of cooling devices that happen to be located near or are operable to manage the flow of cooling air near the user's body part in contact with the device 10.

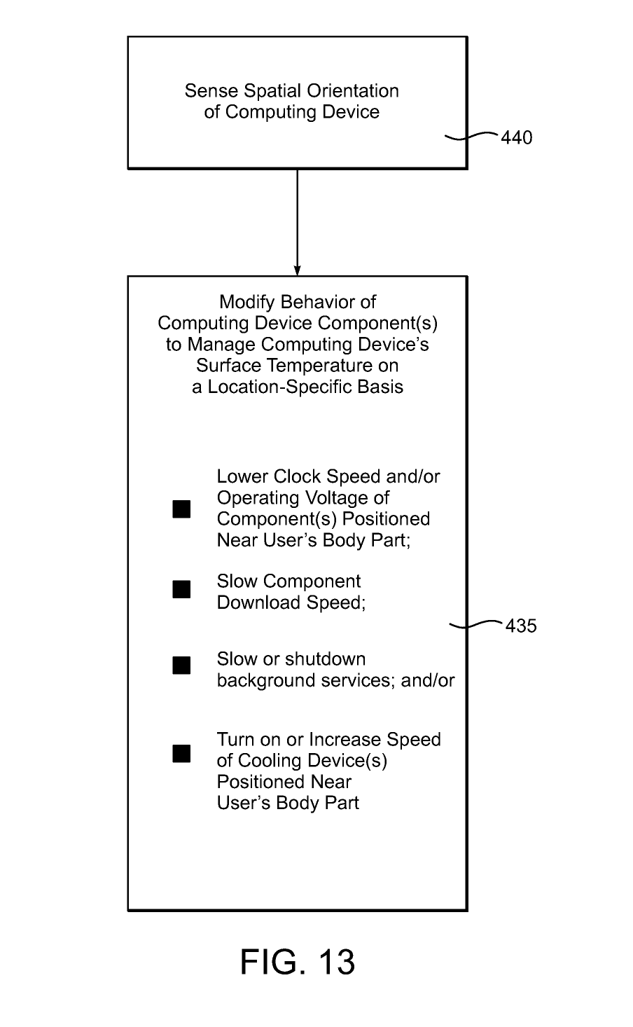

It should be understood that step 435 in FIG. 12 depicts a modification of device component behavior on a location-specific basis based on the detection of user skin contact at a particular location on the device 10. As noted above, the Pressure Sensors 1, 2 . . . n and/or the Temperature Sensors 1, 2 . . . n are operable to pinpoint the location of user skin contact with the device 10. However, and as depicted in FIG. 13, which is an alternate embodiment of the block 435 depicted in FIG. 12, modification of device component behavior may be location-specific, but based on sensing the spatial orientation of the device 10 at block 440 and then modifying device component behavior on a location-specification basis based on the sensed orientation. Block 440 may be performed using, for example, the accelerometer 275 shown in FIG. 7, and along with or in lieu of block 330 in FIG. 8. For example, if the sensed spatial orientation of the device 10 suggests a likely landscape position or a portrait position in the user's hand, then behavior of device components may be modified to manage the thermal environment along the edges of the device 10 where user contact is likely for this or that orientation. A variety of different types of device component behavior modification steps will be performed on a localized basis such as lowering clock speed and/or voltage of components positioned near the likely position of the user's body part, again the slowing of a component download speed, the slowing or shutting down of background surfaces and/or the turning on or increase in speed of cooling devices positioned near the presumed position of a user's body part. Thus, it may be possible to modify the clock speed and operating voltage of those components that are nearest to the likely position of the user's body part in contact with the device 10 and the same is true for modifying the operating characteristics of cooling devices that happen to be located near or are operable to manage the flow of cooling air near the user's body part in contact with the device 10.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents and alternatives falling within the spirit and scope of the invention as defined by the following appended claims.

What is claimed is:

1. An apparatus, comprising:
a case;
a first sensor in the case, the first sensor being operable to generate an output in response to sensing contact with a body part of a user and to transmit the output to a computing device; and
wherein the computing device manages thermal behavior of the computing device responsive to the output.

2. The apparatus of claim 1, comprising a computing device in communication with the first sensor and being operable to receive the output.

3. The apparatus of claim of claim 2, wherein the computing device includes an integrated circuit connected to the first sensor and being operable to manage thermal behavior of the computing device in response to the output of the first sensor.

4. The apparatus of claim 1, wherein the first sensor comprises a temperature sensor or a pressure sensor.

5. The apparatus of claim 1, comprising a second sensor in the case, the second sensor being operable to sense ambient temperature.

6. The apparatus of claim 1, wherein the computing device comprises at least one electric component, the integrated circuit being operable to control the operation of the at least one electric component to manage thermal behavior of the computing device.

7. The apparatus of claim 1, wherein the computing device comprises plural electric components, the integrated circuit being operable to control the operation of at least one of the electric components positioned proximate contact with the body part of the user.

8. An apparatus, comprising:
a handheld case;
a first sensor in the handheld case, the first sensor being operable to generate an output in response to sensing contact with a body part of a user;
an integrated circuit connected to the first sensor and being programmed to manage thermal behavior of the computing device in response to the output of the first sensor.

9. The apparatus of claim 8, wherein the first sensor comprises a temperature sensor or a pressure sensor.

10. The apparatus of claim 8, wherein the computing device comprises plural electric components, the integrated circuit being programmed to control the operation of at least one of the electric components affecting temperature proximate contact with the body part of the user.

11. A method of thermally managing a computing device including a case, a first sensor in the case and an integrated circuit connected to the first sensor, comprising:
using the first sensor to sense contact by a body part of a user and generate an output indicating the contact; and
managing thermal behavior of the computing device in response to the output of the first sensor.

12. The method of claim 11, wherein the computing device includes an integrated circuit connected to the first sensor, the method comprising having the integrated circuit manage thermal behavior of the computing device in response to the output of the first sensor.

13. The method of claim 11, wherein the first sensor comprises a temperature sensor or a pressure sensor.

14. The method of claim 11, wherein the computing device comprises plural electric components, the method comprising controlling the operation of at least one of the electric components affecting temperature proximate a location of contact with the body part of the user.

15. A method of manufacturing, comprising:
providing a case of a computing device, the case being adapted to contact a body part of a user;
placing a first sensor in the case, first sensor being operable to generate an output in response to sensing contact with a body part of a user and to transmit the output to a computing device; and
wherein the computing device manages thermal behavior of the computing device responsive to the output.

16. The method of claim 15, comprising coupling a computing device to be communication with the first sensor and being operable to receive the output.

17. The method of claim 16, wherein the coupling comprises coupling an integrated circuit to the first sensor, the integrated circuit being operable to manage thermal behavior of the computing device in response to the output of the first sensor.

18. The method of claim 15, wherein the first sensor comprises a temperature sensor or a pressure sensor.

19. The method of claim 15, wherein the computing device comprises at least one electric component, the integrated circuit being operable to control the operation of the at least one electric component to manage thermal behavior of the computing device.

20. The method of claim 15, wherein the computing device comprises plural electric components, the integrated circuit being programmed to control the operation of at least one of the electric components affecting temperature proximate a location of contact with the body part of the user.

21. A method of thermally managing a computing device including a case, a first sensor in the case and an integrated circuit connected to the first sensor, comprising:
using the first sensor to sense a spatial orientation of the computing device and generate an output indicating the spatial orientation; and
managing thermal behavior of the computing device in response to the output of the first sensor.

22. An apparatus, comprising:
a computing device operable to receive an output of a first sensor positioned in a case, the output being generated in response to sensing contact with a body part of a user; and
wherein the computing device manages thermal behavior of the computing device responsive to the output.

23. The apparatus of claim 22, comprising a case containing the computing device.

24. The apparatus of claim of claim 22, wherein the computing device includes an integrated circuit connected to the first sensor and being operable to manage thermal behavior of the computing device in response to the output of the first sensor.

25. The apparatus of claim 22, wherein the first sensor comprises a temperature sensor or a pressure sensor.
